(19) United States
(12) Patent Application Publication
(10) Pub. No.: US 2026/0210691 A1
(43) Pub. Date: Jul. 23, 2026

(54) PHASE MODULATION DETECTION OF A LIGHT-PULSE ATOM INTERFEROMETER

(71) Applicant: The Board of Regents of the University of Oklahoma, Norman, OK (US)

(72) Inventors: Grant W. Biedermann, Norman, OK (US); Luke A. Kraft, Norman, OK (US); Samuel A. Meek, Norman, OK (US)

(21) Appl. No.: 19/456,684

(22) Filed: Jan. 22, 2026

Related U.S. Application Data
(60) Provisional application No. 63/748,644, filed on Jan. 23, 2025.

(51) Int. Cl. G01B 9/02001; G01C 19/64

(52) U.S. Cl. CPC G01B 9/02001; G01C 19/64

(57) ABSTRACT

Examples of this disclosure include operating an AIG system to determine rotation rates by generating a light-pulse atom interferometry (LPAI) beam modulated at a modulation frequency and directing the LPAI beam through a beam splitter to thereby split the LPAI beam into three LPAI pulses directed to an interrogation zone of a vacuum. Examples further include generating an atom beam and directing the atom beam to the interrogation zone to interact with the three LPAI pulses. Examples include generating a detection beam and directing the detection beam to a detection zone outside of the interrogation zone to interact with the three LPAI pulses resonant with the atom beam to thereby generate fluorescence signals. Examples include detecting the fluorescence signals generated in the detection zone, demodulating the detected fluorescence signals at two harmonics to thereby form a quadrature pair, and determining an interferometer phase using quadrature pair.

### CROSS-REFERENCE TO RELATED APPLICATIONS

This application claims priority to U.S. Provisional Patent Application No. 63/748,644, filed on Jan. 23, 2025, the entire disclosure of which is incorporated herein by reference.

### STATEMENT REGARDING FEDERALLY SPONSORED RESEARCH OR DEVELOPMENT

Not Applicable.

### BACKGROUND

The exceptional performance of Light-pulse atom interferometer (LPAI) demonstrations has motivated the development of LPAI for fundamental investigations and applications worldwide. Campaigns at the frontiers of science include tests of the Einstein Equivalence Principle, the development of gravitational wave detectors, and interferometry with entangled matter. In the context of inertial navigation, an outstanding challenge is the realization of compact, high performance and robust rotation sensors. The competitive laboratory performance of gyroscopes based on atom interferometry, using both cold and thermal beam approaches, has inspired extensive development and investigations to field this technology. These approaches typically employ two-photon stimulated Raman transitions in alkali atoms, requiring ultra-fast microwave modulation of the optical field and deliberate state preparation of the atomic sample. Recent demonstrations have shown the unique advantages of helium-like alkaline earth metals in this regard, using optical clock interferometer transitions and bosonic strontium with a single ground state.

Fielding these sensors has been the focus of intense effort and world-wide attention. Two primary challenges for these efforts are operation in high-dynamic environments and simplifying optical systems.

### BRIEF DESCRIPTION OF THE DRAWINGS

The disclosed examples are described below with reference to the accompanying drawing figures listed below, wherein:

FIG. 1 is a block diagram illustrating an exemplary atom interferometer gyroscope (AIG) system of this disclosure.

FIG. 2 illustrates a conceptual diagram of a transit-time-resonant (TTR) phase modulation detection technique utilized by AIG systems of this disclosure.

FIG. 3 is a block diagram illustrating a detailed view of an interferometer interrogation zone and detection zone of AIG systems of this disclosure.

FIG. 4 is a block diagram illustrating operations performed by computing devices in performing demodulation of detected fluorescence signals for AIG systems of this disclosure.

FIG. 5 depicts example graphical representations of data processed as part of demodulation performed by AIG systems of this disclosure.

FIG. 6 is a flowchart illustrating a method for operating AIG systems of this disclosure.

FIG. 7 is a flowchart illustrating a method for demodulating detected fluorescence signals to determine rotation rates using AIG systems of this disclosure.

FIG. 8 is a block diagram illustrating a computing device suitable for implementing various aspects of the disclosure.

The various examples will be described in detail with reference to the accompanying drawings. Wherever preferable, the same reference numbers will be used throughout the drawings to refer to the same or like parts. References made throughout this disclosure, relating to specific examples, are provided for illustrative purposes, and are not meant to limit all implementations or to be interpreted as excluding the existence of additional implementations that also incorporate the recited features.

### DETAILED DESCRIPTION

Described herein are strontium thermal beam atom interferometer gyroscopes (AIG) using the ¹S₀→³P₁ intercombination line which detects large rotation rates exceeding six radians per second. In contrast to traditional alkali systems, the presently disclosed clock interferometer approach utilizes a simplified architecture operable without cooling, state preparation, and/or microwave components. The disclosed systems and methods utilize novel phase modulation techniques for detecting the AIG phase which rejects signal background and variations in fringe amplitude. In various examples, the systems and methods can be used for inertial sensing using atom interferometers. The systems and methods disclosed herein find usage in inertial navigation for civilian and defense applications, as well as geodesy surveys. Various technological industries, such as aerospace and defense or small quantum sensing companies, for example, could use this technology to advance the performance of their sensors.

Various traditional thermal beam AIG approaches employ a two-photon stimulated Raman transition in alkali atoms. These approaches shoulder inherent technical complexity, such as fast microwave modulation of the optical field, limited pulse efficiency and state preparation requirements, obfuscating the intrinsic value of these approaches. In strontium-88, the single ground state and the optical clock ¹S₀→³P₁ intercombination line greatly simplifies the laser system approach for a thermal beam AIG and reduces optical power requirements. Examples of this disclosure include strontium thermal beam atom interferometer gyroscopes that leverage these distinct advantages in a minimal setup. Examples of this disclosure include a transit-time-resonant (TTR) phase modulation detection technique that significantly extends the AIG dynamic range and rejects certain systematic and statistical noise sources, allowing for accurate measurements of rotation rates exceeding one revolution per second.

Before further describing various embodiments of the apparatus, component parts, and methods of the present disclosure in more detail by way of exemplary description, examples, and results, it is to be understood that the embodiments of the present disclosure are not limited in application to the details of apparatus, component parts, and methods as set forth in the following description. The embodiments of the apparatus, component parts, and methods of the present disclosure are capable of being practiced or carried out in various ways not explicitly described herein. For example, the various apparatus and devices of the various embodiments described herein may be constructed using various off-the shelf components, such as PCBs, and other mechanical and electrical components which perform the same function as the particular components described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the apparatus, component parts, and methods of the present disclosure have been described in terms of particular embodiments, it will be apparent to those of skill in the art that variations may be applied to the apparatus, component parts, and/or methods and in the steps or in the sequence of steps of the method described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entireties to the same extent as if the contents of each individual patent or publication was specifically and individually incorporated herein.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the methods and compositions of the present disclosure, the following terms and phrases, unless otherwise indicated, shall be understood to have the following meanings: The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The phrase “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error for the apparatus, composition, or the methods or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The terms “about” or “approximately”, where used herein when referring to a measurable value such as an amount, percentage, temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that a thing possesses or occurs in an amount, duration, degree or other measure or parameter value that is 90% to 99% of which the thing is being compared to.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, a range of 1-1,000 includes, for example, 1-10, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 100 units to 2000 units therefore refers to and includes all values or ranges of values of the units, and fractions of the values of the units and integers within said range, including for example, but not limited to 100 units to 1000 units, 100 units to 500 units, 200 units to 1000 units, 300 units to 1500 units, 400 units to 2000 units, 500 units to 2000 units, 500 units to 1000 units, 250 units to 1750 units, 250 units to 1200 units, 750 units to 2000 units, 150 units to 1500 units, 100 units to 1250 units, and 800 units to 1200 units. Any two values within the range of about 100 units to about 2000 units therefore can be used to set the lower and upper boundaries of a range in accordance with the embodiments of the present disclosure. More particularly, a range of 10-12 units includes, for example, 10, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, and 12.0, and all values or ranges of values of the units, and fractions of the values of the units and integers within said range, and ranges which combine the values of the boundaries of different ranges within the series, e.g., 10.1 to 11.5.

Where used herein, the term “integrated circuit” is also intended to refer to a device known as a semiconductor chip, a microchip, a computer chip, and a microprocessor chip.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The term “exemplary” is intended to mean “an example of.”

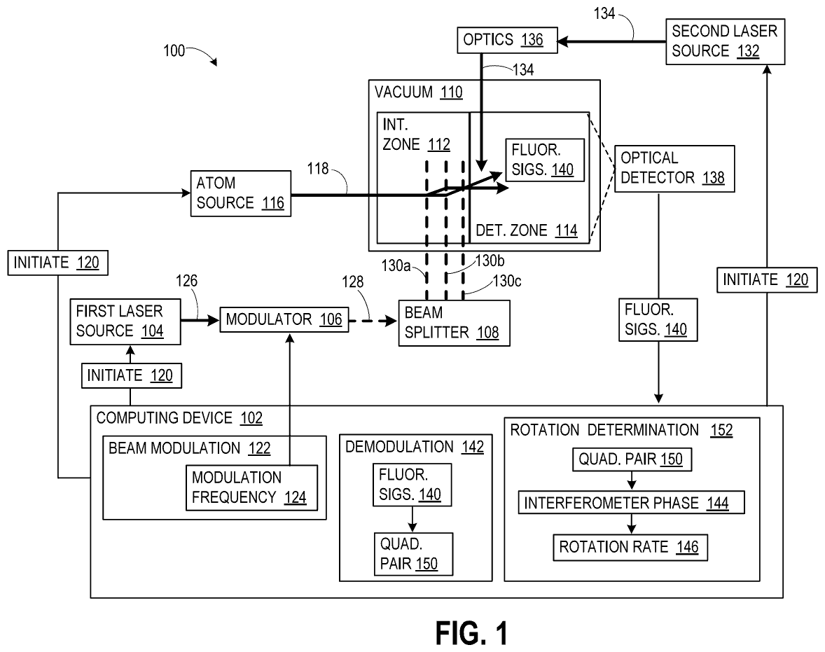

Returning to the description of several embodiments of the disclosure, reference is now made to the figures. FIG. 1 is a block diagram illustrating an exemplary atom interferometer gyroscope (AIG) system 100 of this disclosure. AIG system 100 comprises a computing device 102 operably coupled with various components of AIG system 100 for controlling operation of the AIG system 100, such as a first laser source 104, a modulator 106, an atom source 116, an optical detector 138, and a second laser source 132, as will be discussed in greater detail below.

Computing device 102 can initiate operations of AIG system 100 by sending various initiation signals 120. In some examples, initiation signals 120 are sent based on AIG system 100 being connected to an operational power source, or in response to a user otherwise activating AIG system 100. Computing device 102 can initiate operation of first laser source 104 in generating a light-pulse atom interferometry (LPAI) beam 126.

In some examples, first laser source 104 comprises a stabilized diode laser system locked to a temperature stabilized, optical cavity constructed from ultra-low expansion (ULE) glass. In various examples herein, such as examples where strontium-88 is used as the atom beam 118, LPAI beam 126 generated by first laser source 104 has a wavelength of substantially 689 nm. As 689 nm wavelength light is in the red region of the visible spectrum, LPAI beam 126 may be referred to herein as a red laser light. In some examples, such as many of the examples discussed herein, AIG system 100 leverages the 1S₀-³P₁ intercombination line, which is a direct optical transition in strontium-88. Accordingly, in some examples modulated LPAI beam 128 and thus three LPAI pulses 130a 130b, 130c are light tuned to ¹S₀-³P₁. The 689 nm wavelength is resonant with this transition, allowing for efficient and coherent manipulation of the atomic wave packets. However, those with skill in the art will understand that, according to various embodiments herein, LPAI beam 126 can be generated to have a wavelength greater or less than 689 nm, or can be otherwise tuned based on the atom beam 118 properties and/or setup of the AIG system 100. In various examples, LPAI beam 126 is delivered to modulator 106 by a fiber optics cable.

First laser source 104 is operably coupled with the modulator 106 to direct LPAI beam 126 to the modulator. There, computing device 102 performs beam modulation 122 and modulates the LPAI beam 126 via modulator 106 at a modulation frequency 124 to thereby produce a modulated LPAI beam 128.

In some examples, modulator 106 comprises an acoustic-optic modulator (AOM) configured to phase modulate the LPAI beam 126 by applying the modulation frequency 124 to the radio frequency drive. In some examples, the AOM operates in a double pass configuration in imprinting the modulation frequency 124 onto the LPAI beam 126, to thereby generate the modulated LPAI beam 128.

Modulation frequency 124 can be determined by computing device 102 or assigned by a user as a configurable setting using equation 1,

$${f}_{mod} = v / ( 2 L ) \qquad ( Eq . 1 )$$

In the above equation, v is the atomic velocity of the atom beam 118, and L is the spacing between three LPAI pulses 130a, 130b, 130c. In illustrative examples herein, atom beam 118 comprises strontium-88 having an atom velocity of ~560 m/s, and L is set at 7 mm. Thus, using these values is equation 1, modulation frequency 124 can be ~40 kHz. According to various examples, various values can be used for modulation frequency 124. For example, in some embodiments, modulation frequency 124 is ~30.5 kHz to account for the actual velocity of atoms participating in the interferometer. Those with skill in the art will understand that modulation frequency 124 can be more or less than 30.5 kHz without departing from this disclosure and is chosen based on a transit-time-resonant (TTR) technique such that the phase modulation is resonantly enhanced for atoms whose transit time between the three LPAI pulses 130a, 130b, 130c matches the modulation period. In some examples, modulation frequency 124 can range from ~100 Hz to ~400 kHz, for example, without departing from the scope of this disclosure. In various illustrative examples discussed herein, modulation frequency can be within +/−10 kHz of 30 kHz without departing from the scope of this disclosure. In some examples, the AOM generates the phase modulation with a depth of ±0.277 radian based on measured output modulation strengths of the resulting tone. Because the AOM operates in a double pass configuration, a total phase modulation depth of 0.544 is imprinted on modulated LPAI beam 128.

Modulator 106 is operably coupled with a beam splitter 108 to split modulated LPAI beam 128 into three LPAI pulses 130a, 130b, 130c. Beam splitter 108 is disposed and positioned within AIG system 100 to direct the three LPAI pulses 130a, 130b, 130c to an interrogation zone 112 of a vacuum 110. In various examples disclosed, modulator 106 is operatively coupled with first laser source 104 to apply modulation frequency to LPAI beam 126. However, those with skill in the art will understand that other arrangements are possible and are included as part of this disclosure. In some examples, modulator 106 is arranged to receive the three LPAI beams from beam splitter 108 and apply the modulation frequency 124 to the LPAI beams after being split by beam splitter 108 and before entering interrogation zone 112.

In various examples, beam splitter 108 is used to provide for a Mach-Zehnder system. In various examples, beam splitter 108 comprises a polarizing beam splitting cube that generates a π/2-π-π/2 LPAI pulse sequence via the three LPAI pulses 130a, 130b, 103c. LPAI pulses 130a, 130c are π/2-pulses and LPAI beam pulse 130b is the π-pulse. The polarizing beam-splitting cube receives modulated LPAI beam 128 and divides the beam into two paths. The transmitted light constitutes the π-pulse, while the deflected component becomes the two π/ 2-pulses after being further divided by a 50/50 non-polarizing beam-splitting cube. The three LPAI pulses 130a, 130b, 103c are then incident on three individual cylindrical lenses, one for each pulse. In some examples discussed herein, these lenses are mounted with 7 mm spacing so that, with each LPAI pulses 130a, 130b, 103c incident on the center of a lens, three foci with a measured spacing 7 mm spacing are produced in the focal plane, which falls across the strontium beam (atom beam 118), and accommodates the 21.3 μs lifetime of the ³P₁ excited state. Those with skill in the art will understand this is just an exemplary and illustrative set up for the beam splitter 108, and that various other LPAI pulse sequences and corresponding beam splitter arrangements fall within the scope of this disclosure.

Computing device 102 can initiate operation of atom source 116 in generating an atom beam 118. Atom source 116 is disposed and positioned within AIG system 100 to direct atom beam 118 to the interrogation zone 112 to interact with the three LPAI pulses 130a, 130b, 130c.

As has been discussed herein, according to various examples, atom source 116 comprises a heated strontium-88 source and atom beam 118 comprises strontium atoms in a pure quantum ground state of ¹S₀. In some examples, atom source 116 comprises a strontium oven that produces strontium vapor that is collimated to ~4×10⁹ atom/s thermal beam (atom beam 118) via a micro-capillary array acting as the nozzle. In some examples, the nozzle is an equilateral triangular opening, 4 mm on a side, packed with 211 μm diameter by 8 mm long micro-capillary tubes. The capillaries restrict the divergence angle of the beam to 26 mrad and provide an estimated ~10 m/s full width at half maximum (FWHM) transverse velocity profile. In some examples, the oven can be filled with strontium granules and heated to approximately 420 degrees Celsius with the nozzle held at a slightly higher temperature to prevent strontium deposition and clogging in the capillary array. Those with skill in the art will understand this is just an exemplary and illustrative set up for atom source 116, and that various other strontium-88 and other atom-based sources fall within the scope of this disclosure.

Although the atom source 116 is discussed herein as generating a strontium atom beam 118, those with skill in the art will understand that various other atom sources fall within the scope of this disclosure. In some examples, atom source 116 can comprise, and can generate atom beams 118 comprising, Calcium, Ytterbium, Cesium, Rubidium and other elements possessing at least two long-lived electron orbital states that can be coupled by coherent optical fields. In some examples, atom source 116 can comprise microfabricated atom sources where the capillary array is lithographically defined and etched.

Computing device 102 can initiate operation of second laser source 132 in generating a detection beam 134. Second laser source 132 can be operably coupled with additional optics 136 to direct detection beam 134 into a detection zone 114 of vacuum 110. Detection zone 114 is positioned outside of the 112, and within detection zone 114 are three LPAI pulses 130a, 130b, 130c resonant with atom beam 118. Detection beam 134 is tuned to excite the atoms in detection zone 114 to an excited state. When the atoms decay from the excited state to the ground state, the atoms generate fluorescence signals 140.

In some examples, second laser source 132 comprises a stabilized diode laser system locked to a temperature stabilized, optical cavity constructed from ultra-low expansion (ULE) glass. In various examples herein, such as examples where strontium-88 is used as the atom beam 118, detection beam 134 generated by second laser source 132 has a wavelength of substantially 461 nm. As 461 nm wavelength light is in the blue region of the visible spectrum, LPAI beam 126 may be referred to herein as a blue laser light. In some examples, such as many of the examples discussed herein, AIG system 100 leverages the ¹S₀-¹P₁ line, which is a direct optical transition in strontium-88. Accordingly, in some examples second laser source 132 is light tuned to ¹S₀-¹P₁ to excite the strontium atoms in their ground state immediately after leaving interrogation zone 112 and entering detection zone 114 and thereby measure the population via the emitted fluorescence (fluorescence signals 140) as they decay back to the ground state. In some examples, additional optics 136 is an optical chamber posited such that detection beam 134 is directed to detection zone 114 substantially antiparallel to the three LPAI pulses 130a, 130b, 130c. In various examples, detection beam 134 is directed from second laser source 132 to additional optics 136 or detection zone 114 via fiber optics cables.

The fluorescence signals 140 are detected by optical detector 138 and transmitted to computing device 102. According to various examples, optical detector 138 comprises an avalanche photodiode (APD) module, and the fluorescence signals 140 detected are recorded to the computing device 102.

From there, computing device 102 performs demodulation 142 of the fluorescence signals 140 based on the modulation frequency 124. In some examples, computing device 102 performs two-harmonics demodulation to generate a quadrature pair 150 from the fluorescence signals 140. Using the quadrature pair 150, computing device 102 performs rotation determination 152 to determine an interferometer phase 144. From the interferometer phase 144, the computing device 102 can determine a rotation rate 146 detected by the AIG system 100. Demodulation 142 of fluorescence signals 140 and rotation determination 152 to ultimately determining the rotation rate 146 will be covered in greater detail below.

Although rotation rate is one reading that can be determined based on interferometer phase 144, those with skill in the art will understand that the interferometer phase 144 determined herein can be used by computing device 102 for determining various other readings associated with the interferometer phase 144, such as to measure acceleration rates, electric fields, magnetic fields, or any other external influence that affects the interferometer phase 144. Accordingly, the disclosure herein is not limited to gyroscopes, but includes any system measuring external influences that affect interferometer phase 144.

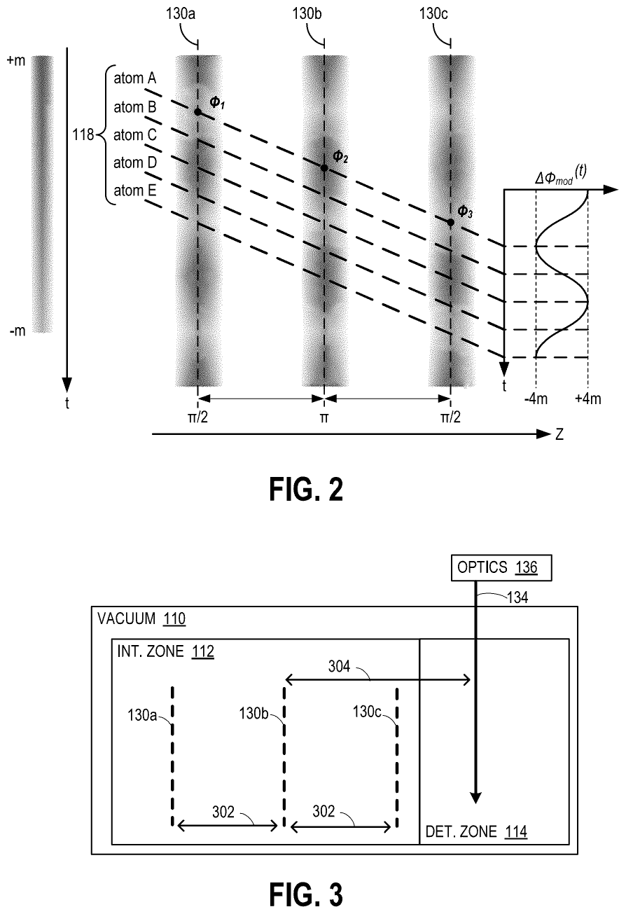

FIG. 2 illustrates a conceptual diagram of TTR phase modulation detection technique utilized by AIG system 100 herein. Atoms traversing the interferometer region receive a phase imprint, φᵢ from the three LPAI pulses 130a, 130b, 130c at each pulse which is modulated at a frequency resonant with the inverse of the atom transit time. Depending on the time at which atoms enter the interferometer, the LPAI phase shift varies between Δφ_mod=±4 m as shown. This modulated phase shift is detected in the fluorescence signals 140 during readout and demodulated to acquire the inertial phase shift Δφ^{(I)} of the AIG.

FIG. 3 illustrates a detailed view of the interrogation zone 112 and detection zone 114. As shown three LPAI pulses 130a, 130b, 130c are separated by and pulse separation distance 302. Pulse separation distance 302 can be configurable by an operator of AIG system 100. As has been discussed herein, in some examples, pulse separation distance 302 is set to 7 mm. In various examples herein where atom beam 118 comprises a strontium thermal beam, the spacing provided by pulse separation distance 302 set at 7 mm accommodates the lifetime of the ³P₁ state (21.3 μs), so that atoms can coherently interact with all three LPAI pulses 130a, 130b, 130c before significant spontaneous decay occurs.

Detection beam 134 can be offset from the middle LPAI beam pulse 130b by an offset distance 304. Additional optics 136 can be positioned to ensure detection beam 134 enter detection zone 114 at a desired offset distance 304 and antiparallel to three LPAI pulses 130a, 130b, 130c. Offset distance 304 is a distance that ensures the atoms can reach the detection beam 134 in the excited state before significant spontaneous decay occurs. In various examples herein where atom beam 118 comprises a strontium thermal beam, the lifetime of the excited ³P₁ state in strontium atoms is considered to be 21.3 μs. This is the average time an atom remains in the ³P₁ state before spontaneously decaying back to the ground state (¹S₀). In some examples, offset distance 304 is set to 10.9 mm to capture atoms in the ³P₁ state. Those with skill in the art will understand that offset distance 304 can be various values based on various factors, such as atoms used as atom beam 118, the pulse separation distance 302, and various other factors associated with interrogation zone 112 and/or detection zone 114.

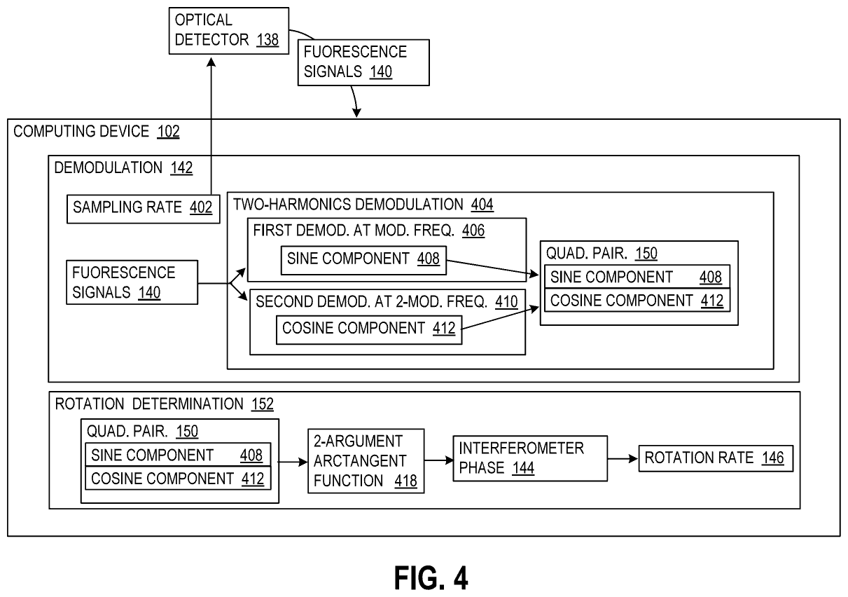

FIG. 4 is a block diagram illustrating operations performed by computing device 102 in performing demodulation 142 of the detected fluorescence signals 140. As shown, computing device 102 receives detected fluorescence signals 140 from optical detector 138. In some examples, computing device 102 controls optical detector 138 in detecting fluorescence signals 140 according to a configurable sampling rate 402. In some examples, configurable sampling rate 402 is determined based on modulation frequency 124, and in some examples is set to according to equation 2.

$${f}_{{s}_{a} mp} = 8 \times {ω}_{{m}_{o}} d / ( 2 π ) \qquad ( Eq . 2 )$$

Thus, configurable sampling rate 402 can be a multiple of modulation frequency 124, such as eight times modulation frequency 124 as shown in equation 2, but can be more or less than eight times the modulation frequency 124 according to various embodiments of this disclosure. According to various examples discussed herein, modulation frequency 124 is 30.5 kHz, and thus, using equation 2, configurable sampling rate 402 is set at 244 kHz.

Upon receiving the detected fluorescence signals 140, computing device 102 performs demodulation 142, and specifically can perform two-harmonics demodulation 404. As part of the two-harmonics demodulation 404, fluorescence signals 140 are subject to a first demodulation 406 at the modulation frequency 124 (the fundamental frequency), and a second demodulation 410 at twice the modulation frequency 124 (the fundamental frequency's second harmonic). Thereby, first demodulation 406 generates a sine component 408 and second demodulation 410 generates a cosine component 412. Thereby, two-harmonics demodulation 404 generates a quadrature pair 150 including the sine component 408 and the cosine component 412.

Although demodulation using two harmonics is described, those with skill in the art will recognize that demodulation can comprise using one harmonic according to various examples of this disclosure. In other examples of this disclosure, more than two harmonics are used for demodulation. Additionally, examples herein describe using the first two harmonics (at the modulation frequency and twice the modulation frequency) for demodulation. However, in various other examples of this disclosure, higher harmonics are used to perform demodulation.

Using the quadrature pair 150, computing device 102 can further perform rotation determination 152. As shown, computing device 102 can apply the sine component 408 and cosine component 412 of the quadrature pair 150 to a two-argument arctangent function 418 to determine the interferometer phase 144. Equation 3 below shows how the two-argument arctangent function 418 is applied to the sine component 408 and cosine component 412 to generate the interferometer phase 144.

$$Δϕ = a tan 2 ( {F}_{1}^{′} , {F}_{2}^{′} ) \qquad ( Eq . 3 )$$

In equation 3, Δφ is the interferometer phase 144, F₁′ is the amplitude of the sine component 408, and F₂′ is the amplitude of the cosine component 412. Examples of this disclosure include any computer hardware or software equivalent of equations 3 for determining the interferometer phase 144 based on the sine component 408 and cosine component 412, such as programs utilizing rotations of the components in vector space, for example.

Further, using the quadrature pair 150 and/or the interferometer phase 144 determined therefrom, computing device 102 can determine a rotation rate 146 detected by the AIG system 100. Specifically, computing device 102 can determine the rotation rate 146 using equation 4 below.

$${Ω}_{a} = a tan 2 ( {F}_{1}^{′} , {F}_{2}^{′} ) {\overline{v}}_{e} / ( 2 {kL}^{2} ) \qquad ( Eq . 4 )$$

In equation 4, Ωₐ is the rotation rate 146 detected by the AIG system 100, v̅ₑ is the effective mean longitudinal velocity of atoms participating in the interferometer, k is the angular wave number of the excitation pulses (three LPAI pulses 130a, 130b, 130c), and L is the pulse separation distance 302. In various examples discussed herein, the v̅ₑ for the strontium atoms discussed is 560 m/s, the k value for the three LPAI pulses 130a, 130b, 130c discussed herein is 2π×1450434 m⁻¹, and L is 7 mm (as discussed in reference to FIG. 3). The values disclosed are exemplary, and equation 4 can be used to determine rotation rates 146 according to various interferometer setup-specific factors.

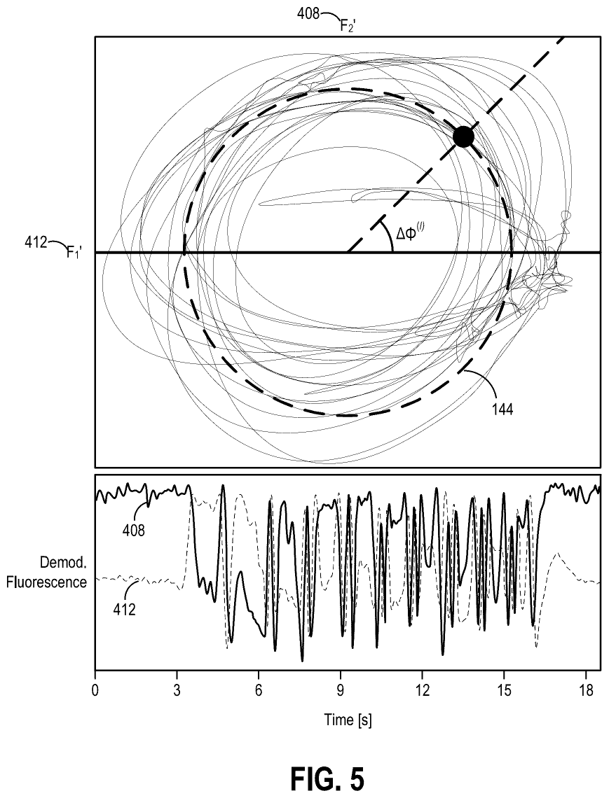

FIG. 5 depicts example graphical representations of data processed as part of demodulation 142. The bottom section of FIG. 5 illustrates a time trace of the fluorescence signal demodulated at the modulation frequency as part of first demodulation 406 (sine component 408, the solid line) and twice the modulation frequency as part of second demodulation 410 (cosine component 412, the dashed line depicted). The top section of FIG. 5 illustrates the sine component 408 signal vs. the cosine component 412 signal in solid line, and illustrates that the interferometer phase 144 can be determined for each coordinate (sine component 408, cosine component 412), using the two-argument arctangent function 418, as shown by the dashed-line circle.

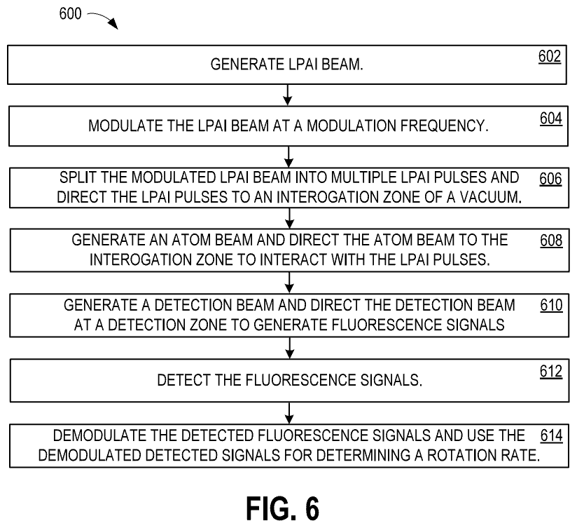

FIG. 6 is a flowchart illustrating a method 600 for operating an AIG system, such as AIG system 100, for example. Method 600 can start at block 602 by computing device 102 generating LPAI beam 126 using first laser source 104. Method 600 can continue to block 604 by computing device 102 modulating LPAI beam 126 at a modulation frequency 124 using modulator 106 to form modulated LPAI beam 128. Method 600 can continue to block 606 by splitting the modulated LPAI beam 128 using beam splitter to form three LPAI pulses 130a, 130b, 130c, and directing the three LPAI pulses 130a, 130b, 130c to interrogation zone 112. In various examples, first laser source 104 and modulator 106 are disposed within AIG system 100 such that the modulated LPAI beam 128 is directed through the beam splitter 108, and the beam splitter 108 is disposed to direct the three LPAI pulses 130a, 130b, 130c to the interrogation zone 112.

Method 600 can continue to block 608 where computing device 102 generates atom beam 118 using atom source 116. In various examples, the atom source 116 is disposed to direct the atom beam 118 to the interrogation zone 112 to interact with the three LPAI pulses 130a, 130b, 130c. Method 600 can continue to block 610 where computing device 102 generates a detection beam 134 using second laser source 132. In some examples, second laser source 132 and optionally additional optics 136 are disposed to direct detection beam 134 to detection zone 114, outside of interrogation zone 112, to interact with the three LPAI pulses 130a, 130b, 130c resonant with atom beam 118 to thereby generate fluorescence signals 140.

Method 600 can continue to block 612 by computing device 102 detecting the fluorescence signals 140 using optical detector 138. Method 600 can continue to block 614 demodulating the detected fluorescence signals 140 to thereby determine a rotation rate 146 detected by the AIG system 100.

Method 600 depicts blocks 602-614 being performed in a certain order, but those with skill in the art will recognize that blocks 602-614 can be performed in any of a number of orders without departing from the scope of this disclosure. Additionally, method 600 can include more or less than the blocks 602-614 without departing from the scope of this disclosure.

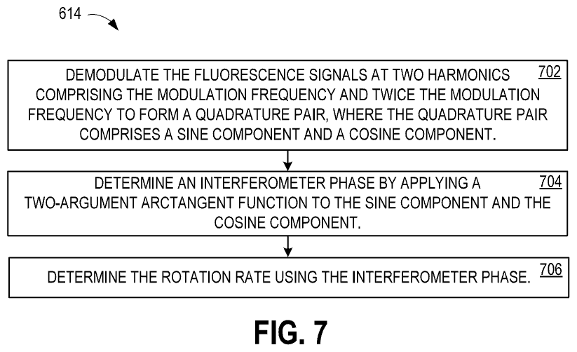

FIG. 7 is a flowchart illustrating a method for demodulating detected fluorescence signals 140 to determine a rotation rate, such as the demodulation of rotation rate determination of block 614. Block 614 can begin at block 702 by computing device 102 performing two-harmonics demodulation 404 and demodulating fluorescence signals 140 at the modulation frequency 124 by first demodulation 406 to generate sine component 408, and at twice the modulation frequency 124 by second demodulation 410 to generate cosine component 412. Thereby, computing device 102 generates quadrature pair 150 comprising sine component 408 and cosine component 412.

Block 614 can continue to block 704 by computing device 102 performing rotation determination 152 to determine interferometer phase 144 by applying two-argument arctangent function 418 to quadrature pair 150. Block 614 can continue to 706 by computing device 102 performing rotation determination 152 to determine rotation rate 146 using the interferometer phase 144.

FIG. 7 depicts blocks 702-706 being performed in a certain order, but those with skill in the art will recognize that blocks 702-706 can be performed in any of a number of orders without departing from the scope of this disclosure. Additionally, method 600 can include more or less than the blocks 702-706 without departing from the scope of this disclosure.

The systems herein, such as AIG system 100, offer various advantages over traditional systems herein, such as reduced weight, reduced size, and reduced power requirements, for example. As mentioned previously, various traditional systems employ two-photon stimulated Raman transitions in alkali atoms, requiring ultra-fast microwave modulation of the optical field and deliberate state preparation of the atomic sample. In contrast to these traditional systems, systems herein utilizing the strontium-88 atom source do not require cooling, state preparation, or microwave components. That is, the atom beam travels directly from the atom source to the interrogation zone without any intervening state preparation. Thus, the systems disclosed herein provide for a simplified set up, providing reduced size and weight of the systems since the systems do not require additional components needed by traditional systems for state preparation. Thus, systems herein are very compact in size and weight when compared to traditional systems.

Systems herein further allow for reduced power for powering the LPAI laser source (first laser source 104) when compared to traditional systems. Systems herein allow for first laser source 104 to be powered by approximately 10 milliwatts of power, or even less, which is far less than power required by traditional system for powering the LPAI laser source. In the single photon transition systems described herein, the linewidth of the transitions along with the associated saturation intensities make large Rabi Frequencies attainable for relatively low powers, and thus appropriate power is easily achieved using low-power supply systems. Systems with strontium atom sources, such as those described herein, provide for especially improved power saving due to the use of low-frequency modulators and by requiring no state preparation. This is achievable due to the optical dipole moment (the strength of the response) of the atom to the optical field.

Systems herein further provide for accurate rotation rate measurements, even at rotation rates giving a phase shift larger than approximately 1 radian, and larger than what is detectable by many traditional systems. Examples of this disclosure include the transit-time-resonant phase modulation detection technique, discussed in detail herein, that significantly extends the AIG dynamic range and rejects certain systematic and statistical noise sources, allowing for accurate measurements of rotation rates exceeding six radians per second.

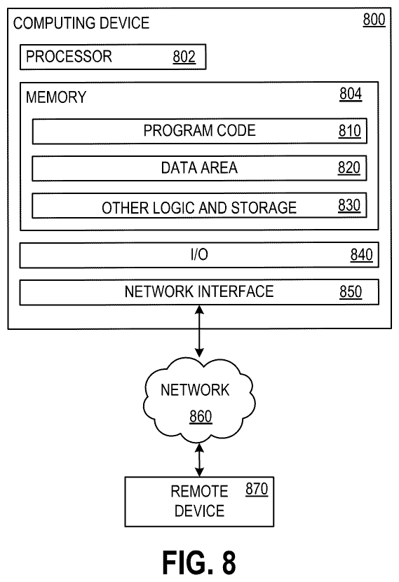

FIG. 8 is a block diagram illustrating computing device 800 that may be used as any component described herein that may require computational or storage capacity, such as computing device 102, for example. Computing device 800 has at least a processor 802 and a memory 804 that holds program code 810, data area 820, and other logic and storage 830. Memory 804 is any device allowing information, such as computer executable instructions and/or other data, to be stored and retrieved. For example, memory 804 may include one or more random access memory (RAM) modules, flash memory modules, hard disks, solid-state disks, persistent memory devices, and/or optical disks. Program code 810 comprises computer executable instructions and computer executable components including instructions used to perform operations described herein. Data area 820 holds data used to perform operations described herein. Memory 804 also includes other logic and storage 830 that performs or facilitates other functions disclosed herein or otherwise required of computing device 800. An input/output (I/O) component 840 facilitates receiving input from users and other devices and generating displays for users and outputs for other devices. In various examples, computing device 800 comprises programmable logic in the form of a field-programmable gate array (FPGA). A network interface 850 permits communication over external network 860 with a remote device 870, which may represent another implementation of computing device 800. For example, a remote device 870 may represent another of the above-noted devices within AIG system 100. In various examples, remote device 870 comprises a user device or another device that receives determinations made by computing device 102, such as interferometer phase 144 and/or rotation rate 146, for example. For example, remote device 870 can comprise a user interface where interferometer phase 144 and/or rotation rate 146 is displayed to a user in real-time. In some examples, remote device 870 can comprise a device that is controlled by or otherwise uses interferometer phase 144 and/or rotation rate 146 during operation of remote device 870, such as a navigation devices, personal electronic device, wearable devices, robotic device, automobiles, aerospace vehicles, marine vehicle, remotely-operate vehicles, or any other device that is operated based on or uses interferometer phase and/or rotational rate readings for operational purposes.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media. The term “computer readable media” may be one or more integrated circuits.

### Additional Examples

An example method of this disclosure includes operating an AIG system to determine rotation rates by generating, using a first laser source and an optical modulator, a light-pulse atom interferometry (LPAI) beam modulated at a modulation frequency, wherein the first laser source and the optical modulator are disposed such that the LPAI beam is directed through a beam splitter to thereby split the LPAI beam into three LPAI pulses directed to an interrogation zone of a vacuum; generating, using an atom source, an atom beam, wherein the atom source is disposed to direct the atom beam to the interrogation zone to interact with the three LPAI pulses; generating, by a second laser source, a detection beam, wherein the detection beam is disposed to direct the detection beam to a detection zone outside of the interrogation zone to interact with the three LPAI pulses resonant with the atom beam to thereby generate fluorescence signals; detecting, using an optical detector, the fluorescence signals generated in the detection zone; demodulating the detected fluorescence signals at two harmonics to thereby form a quadrature pair; and determining an interferometer phase using the quadrature pair.

Alternatively, or in addition to the other examples described herein, examples include any combination of the following:
determining a rotation rate using the interferometer phase.
the quadrature pair comprises a sine component and a cosine component; and the interferometer phase is determined by applying a two-argument arctangent function to the sine component and the cosine component.
the optical modulator comprises an acoustic-optic modulator (AOM) operating in a double pass configuration in imprinting the modulation frequency onto the LPAI beam.
the atom source comprises a heated strontium-88 source and the atom beam comprises a thermal strontium beam.
the atom beam comprises strontium atoms in a pure quantum ground state of ¹S₀.
each of the three LPAI pulses are beams of resonant light tuned to ¹S₀-³P₁.
the atom beam travels directly from the atom source to the interrogation zone without any intervening state preparation.

Example systems of this disclosure include a processor; and a computer-readable medium storing instructions that are executable by the processor to perform the method described above.

One or more example computer storage mediums of this disclosure has computer-executable instructions stored thereon, which, upon execution by a computer, cause the computer to perform the method described above.

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method for operating an atom interferometer system, the method comprising:
generating, by a processor using a first laser source and an optical modulator, a light-pulse atom interferometry (LPAI) beam modulated at a modulation frequency, wherein the first laser source and the optical modulator are disposed such that the LPAI beam is directed through a beam splitter to thereby split the LPAI beam into three LPAI pulses directed to an interrogation zone of a vacuum;
generating, by the processor using an atom source, an atom beam, wherein the atom source is disposed to direct the atom beam to the interrogation zone to interact with the three LPAI pulses;
generating, by the processor using a second laser source, a detection beam, wherein the detection beam is disposed to direct the detection beam to a detection zone outside of the interrogation zone to interact with the three LPAI pulses resonant with the atom beam to thereby generate fluorescence signals;
detecting, by the processor using an optical detector, the fluorescence signals generated in the detection zone;
demodulating, by the processor, the detected fluorescence signals at two harmonics to thereby form a quadrature pair; and
determining, by the processor, an interferometer phase using the quadrature pair.

2. The method of claim 1, wherein:
the quadrature pair comprises a sine component and a cosine component;
the interferometer phase is determined by applying a two-argument arctangent function to the sine component and the cosine component; and
the method further comprises determining, by the processor, a rotation rate using the interferometer phase.

3. The method of claim 1, wherein the optical modulator comprises an acoustic-optic modulator (AOM) operating in a double pass configuration in imprinting the modulation frequency onto the LPAI beam.

4. The method of claim 1, wherein the atom source comprises a heated strontium-88 source and the atom beam comprises a thermal strontium beam.

5. The method of claim 4, wherein the atom beam comprises strontium atoms in a pure quantum ground state of ¹S₀.

6. The method of claim 5, wherein each of the three LPAI pulses are beams of resonant light tuned to ¹S₀-³P₁.

7. The method of claim 1, wherein the atom beam travels directly from the atom source to the interrogation zone without any intervening state preparation.

8. An atom interferometer system comprising:
a processor; and
a computer-readable medium including instructions executable by the processor to:
generate, using a first laser source and an optical modulator, a light-pulse atom interferometry (LPAI) beam modulated at a modulation frequency, wherein the first laser source and the optical modulator are disposed such that the LPAI beam is directed through a beam splitter to thereby split the LPAI beam into three LPAI pulses directed to an interrogation zone of a vacuum;
generate, using an atom source, an atom beam, wherein the atom source is disposed to direct the atom beam to the interrogation zone to interact with the three LPAI pulses;
generate, using a second laser source, a detection beam, wherein the detection beam is disposed to direct the detection beam to a detection zone outside of the interrogation zone to interact with the three LPAI pulses resonant with the atom beam to thereby generate fluorescence signals;
detect, using an optical detector, the fluorescence signals generated in the detection zone;
demodulate the detected fluorescence signals at two harmonics to thereby form a quadrature pair; and
determine an interferometer phase using the quadrature pair.

9. The atom interferometer system of claim 8, wherein:
the quadrature pair comprises a sine component and a cosine component
the interferometer phase is determined by applying a two-argument arctangent function to the sine component and the cosine component; and
the computer-readable medium further includes instructions executable by the processor to determine a rotation rate using the interferometer phase.

10. The atom interferometer system of claim 8, wherein the optical modulator comprises an acoustic-optic modulator (AOM) operating in a double pass configuration in imprinting the modulation frequency onto the LPAI beam.

11. The atom interferometer system of claim 8, wherein the atom source comprises a heated strontium-88 source and the atom beam comprises a thermal strontium beam.

12. The atom interferometer system of claim 11, wherein the atom beam comprises strontium atoms in a pure quantum ground state of ¹S₀.

13. The atom interferometer system of claim 12, wherein each of the three LPAI pulses are beams of resonant light tuned to ¹S₀-³P₁.

14. The atom interferometer system of claim 8, wherein the atom beam travels directly from the atom source to the interrogation zone without any intervening state preparation.

15. A computer-readable medium including instructions executable by a processor to:
generate, using a first laser source and an optical modulator, a light-pulse atom interferometry (LPAI) beam modulated at a modulation frequency, wherein the first laser source and the optical modulator are disposed such that the LPAI beam is directed through a beam splitter to thereby split the LPAI beam into three LPAI pulses directed to an interrogation zone of a vacuum;
generate, using an atom source, an atom beam, wherein the atom source is disposed to direct the atom beam to the interrogation zone to interact with the three LPAI pulses;
generate, using a second laser source, a detection beam, wherein the detection beam is disposed to direct the detection beam to a detection zone outside of the interrogation zone to interact with the three LPAI pulses resonant with the atom beam to thereby generate fluorescence signals;
detect, using an optical detector, the fluorescence signals generated in the detection zone;
demodulate the detected fluorescence signals at two harmonics to thereby form a quadrature pair; and
determine an interferometer phase using the quadrature pair.

16. The computer-readable medium of claim 15, wherein:
the quadrature pair comprises a sine component and a cosine component;
the interferometer phase is determined by applying a two-argument arctangent function to the sine component and the cosine component; and
the computer-readable medium further includes instructions executable by the processor to determine a rotation rate using the interferometer phase.

17. The computer-readable medium of claim 15, wherein the optical modulator comprises an acoustic-optic modulator (AOM) operating in a double pass configuration in imprinting the modulation frequency onto the LPAI beam.

18. The computer-readable medium of claim 15, wherein the atom source comprises a heated strontium-88 source and the atom beam comprises a thermal strontium beam.

19. The computer-readable medium of claim 18, wherein the atom beam comprises strontium atoms in a pure quantum ground state of ¹S₀.

20. The computer-readable medium of claim 19, wherein each of the three LPAI pulses are beams of resonant light tuned to ¹S₀-³P₁.
